(19) United States
(12) Patent Application Publication
(10) Pub. No.: US 2020/0050054 A1
(43) Pub. Date: Feb. 13, 2020

(54) STACKED HEAD-UP DISPLAY PANEL PROVIDING POLARIZED SUNGLASSES COMPATABILITY AND SUNLIGHT RESISTANCE

(71) Applicant: Visteon Global Technologies, Inc., Van Buren Township, MI (US)

(72) Inventors: Chao-Hung Lin, Canton, MI (US); Paul Fredrick Luther Weindorf, Novi, MI (US); Sebastien Hervy, Trie-Chateau (FR)

(21) Appl. No.: 16/059,869

(22) Filed: Aug. 9, 2018

(51) Int. Cl. G02F 1/1335; G02B 27/01; G02B 5/30

(52) U.S. Cl. CPC G02F 1/133528; G02B 27/0172; G02B 2027/0178; G02B 5/3025; G02B 27/0176

(57) ABSTRACT

A head-up display (HUD) compatible with polarized sunglasses is disclosed. The HUD includes a thin-film transistor liquid crystal display (TFT-LCD), an active polarization modulator, and a wavelength filter. The active polarization modulator and the wavelength filter are optically bonded to the TFT-LCD. The active polarization modulator is configured to modulate a polarization from the TFT-LCD. The wavelength filter is configured to increase a sunlight resistance of the TFT-LCD.

### BACKGROUND

During high sunlight situations, people may wear sunglasses, including polarized sunglasses, while viewing a traditional head-up display (HUD). Such people may see ghost images on the traditional HUD, which are caused by reflections as a result of lighting interacting with the multiple internal surfaces of the components of the traditional HUD, specifically a thin-film transistor (TFT) liquid crystal display (LCD), an active polarization modulator such as a twisted nematic (TN) cell, and a hot mirror. When the TN cell and the hot mirror are placed in front of the TFT-LCD, four additional optical surfaces are introduced and ghost images are induced by these surfaces. Such ghost images and reflections can make it difficult for a user to clearly view the images on the traditional HUD. For example, ghost images reduce the contrast of the display content.

### SUMMARY

This section provides a general summary of the present disclosure and is not a comprehensive disclosure of its full scope or all of its features, aspects, and objectives.

Disclosed herein are example implementations of a head-up display (HUD). One example HUD includes a thin-film transistor liquid crystal display (TFT-LCD), an active polarization modulator, and a wavelength filter. The active polarization modulator and the wavelength filter are optically bonded to the TFT-LCD.

Also disclosed herein are example implementations of a system for a HUD. One example system includes an active polarization modulator front plate and a coating. The coating is adjacent to the active polarization modulator front plate. The system also includes an active polarization modulator rear plate, and an LCD front plate. The system further includes a first reflective polarizer and an LCD rear plate. The first reflective polarizer is adjacent to the active polarization modulator rear plate and the LCD front plate. The system further includes a second reflective polarizer. The second reflective polarizer is adjacent to the LCD rear plate.

Also disclosed herein are example implementations of a display device compatible with polarized sunglasses. One example display device includes a display for displaying information and a half-wave plate. The display includes stacked components to reduce internal surfaces. The half-wave plate is coupled to the display and arranged to receive S-polarized light from the display. The stacked components reduce a ghost image on the display.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a diagrammatic view illustrating the angles of polarized light in a HUD system in accordance with aspects of the present disclosure;

FIG. 2A is a diagrammatic view of a stacked HUD panel in accordance with aspects of the present disclosure;

FIG. 2B is a diagrammatic view of a stacked HUD panel with an air gap in accordance with aspects of the present disclosure;

FIG. 3 is a simplified, idealized graph showing the qualitative behavior of light reflectivity versus angle of incidence in accordance with aspects of the present disclosure;

FIG. 4 is a simplified, idealized graph showing the qualitative behavior of light reflectivity versus a combiner inclination in accordance with aspects of the present disclosure;

FIG. 5 is a simplified, idealized graph showing the qualitative behavior of S-polarization and P-polarization reflectivity ratio of light versus angle of incidence in accordance with aspects of the present disclosure;

FIG. 6 is a simplified, idealized graph showing the qualitative behavior of S-polarization and P-polarization reflectivity ratio of light versus combiner inclination in accordance with aspects of the present disclosure;

FIG. 7 is a diagram of an electrical polarization rotator of a HUD system in accordance with aspects of the present disclosure;

FIG. 8 is a graph showing a solar radiation spectrum of sun loading in accordance with aspects of the present disclosure; and

FIG. 9 is a diagram showing reflective and transmitted light in accordance with aspects of the present disclosure.

### DETAILED DESCRIPTION

The following description is merely exemplary in nature and is not intended to limit the disclosure in its application or uses. For purposes of clarity, the same reference numbers are used in the description and drawings to identify similar elements.

A head-up display (HUD) panel that offers both improved viewing by a user wearing polarized sunglasses and improved viewing in high sunlight situations is desirable. Certain embodiments of the present disclosure may, for example, relate to a HUD panel that offers improved viewing by a user wearing polarized sunglasses and improved viewing in high sunlight situations. Certain embodiments may combine the internal surfaces of components of the HUD panel, eliminating the reflections and ghost images. For example, one or more embodiments may describe stacking discrete components in a picture generation unit (PGU) of the HUD to provide a compact PGU design. One or more embodiments may describe reducing or eliminating extra optical surfaces, which traditionally result from stacking discrete components, like a TFT-LCD, an active polarization modulator, such as a TN cell, and a hot mirror. Reducing or eliminating the extra optical surfaces may reduce or eliminate ghosting.

The term HUD is used herein to refer to display devices employed in components or systems, such as but not limited to a window of a vehicle, lens, or visor.

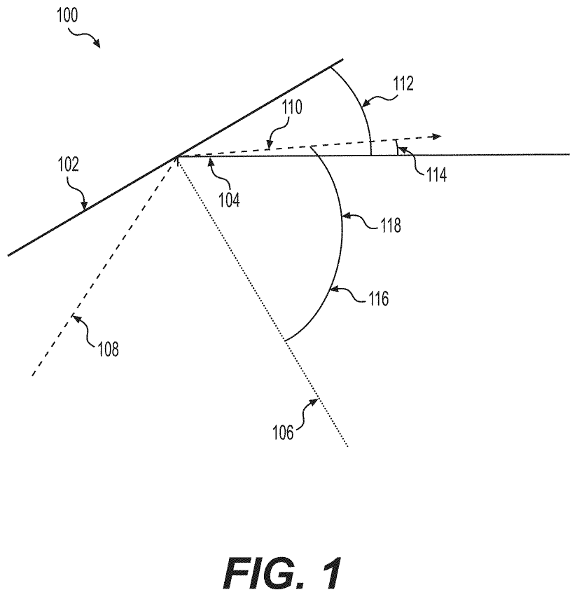

FIG. 1 illustrates angles 100 of an example HUD system. The angles 100 of the HUD system are formed from various axis, such as a combiner 102, a horizon 104, a combiner normal 106, and a HUD gut ray 108. The HUD gut ray 108 travels toward the combiner 102 and is reflected as reflected HUD gut ray 110. The combiner 102 includes a combiner inclination (w) 112 represented by ω=90−θ+α, where a is a look down angle 114 and θ is a reflection angle 116. The look down angle (α) 114 is the angle that is calculated from the horizon 104. The combiner normal 106 is perpendicular to the combiner 102. The combiner 102 can be, for example, a windshield of a vehicle. The combiner normal 106 can be a windshield normal. A windshield azimuth angle can make P-polarization and S-polarization not align with vertical and horizontal, respectively, to a driver's sight. For example, a front view of the windshield can include a plane of vertical and a plane of reflection. The plane of vertical can define horizontal and vertical orientations. The plane of reflection can define S-polarization and P-polarization orientations. The reflection angle (θ) 116 equals an incident angle 118. The incident angle 118 is formed between the HUD gut ray 110 and the combiner normal 106.

Light passing through the HUD panel 200 may be reflected or polarized. For example, light that is P-polarized is polarized parallel to a plane of incidence which in a HUD is the plane formed by gut rays 108 and 110. Light that is S-polarized is polarized perpendicular to a plane of incidence. A TFT-LCD polarizes light in either P-polarization or S-polarization.

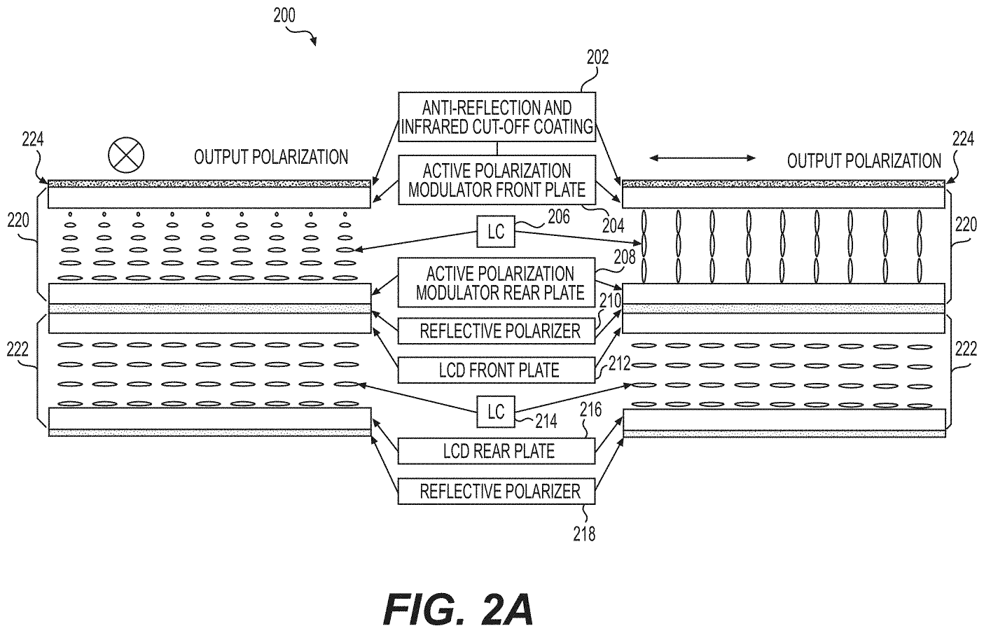

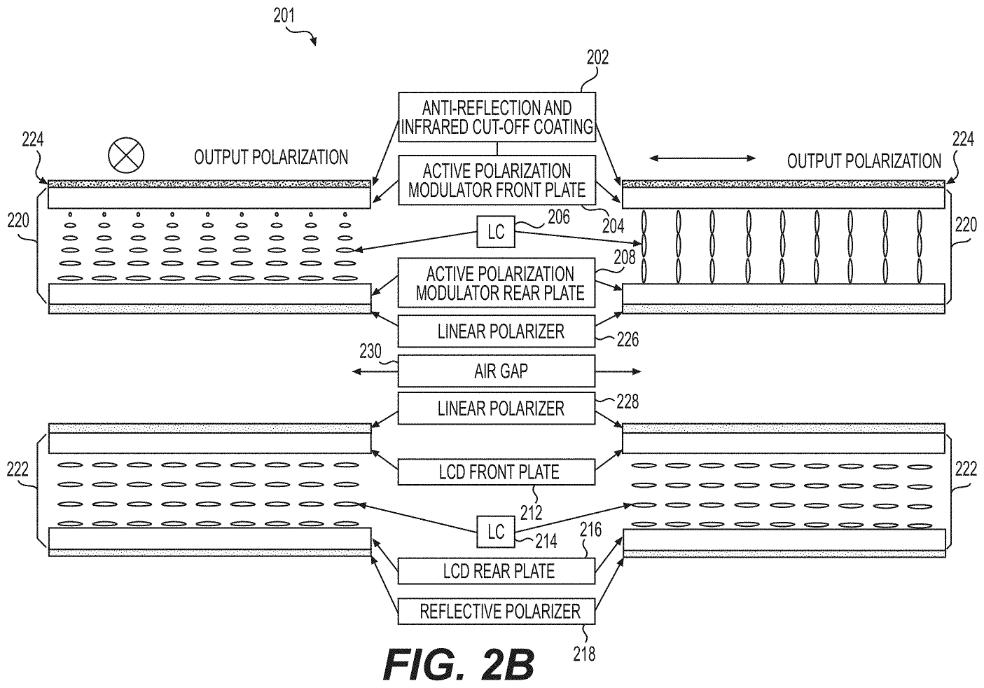

FIG. 2A illustrates a stacked HUD panel 200 in accordance with aspects of the present disclosure. The HUD panel 200, in this example, includes an anti-reflection and infrared cut-off coating 202, an active polarization modulator front plate 204, a first liquid crystal (LC) 206, an active polarization modulator rear plate 208, a first reflective polarizer 210, an LCD front plate 212, a second LC 214, an LCD rear plate 216, and a second reflective polarizer 218. The TN cell 220 (stack of 204, 206, 208, and 210) is used both as the substrate of the TFT-LCD 222 to provide polarization control (for polarized sunglasses) and as a hot mirror 224 (stack of 202 and 204) (for sunlight/infrared resistance), eliminating two internal surfaces. The now-integrated TN cell 220 and hot mirror 224 are optically bonded to the TFT-LCD 222 (stack of 210, 212, 214, 216, and 218) by sharing reflective polarizer 210 to eliminate the remaining two internal surfaces. The now-integrated TN cell 220 and hot mirror 224 may be optically bonded to the TFT-LCD 222 by using a liquid adhesive or any other desirable adhesive or bond. The resulting stacked HUD panel 200 contains only the original two surfaces of the TFT-LCD 222. The TFT-LCD 222 includes its own polarizer that is the reflective type to reflect any excessive amount of solar radiation entering the stacked HUD panel 200 as well as to reflect unusable light energy from within.

In one example embodiment, the stacked HUD TFT-LCD can be configured as follows: 1) the anti-reflection and infrared cut-off coating 202 is positioned adjacent the active polarization modulator front plate 204; 2) the first LC 206 is positioned between the active polarization modulator front plate 204 and the active polarization modulator rear plate 208; 3) the first reflective polarizer 210 is positioned adjacent the LCD front plate 212; 4) the second LC 214 is positioned between the LCD front plate 212 and the LCD rear plate 216; and 5) the second reflective polarizer 218 is positioned adjacent the LCD rear plate 216. The HUD panel 200 can include additional and/or fewer components and configurations and is not limited to those illustrated in FIG. 2A.

The HUD panel 200 can be incorporated into a windshield of a vehicle. For a windshield HUD (WHUD) to be compatible with polarized sunglasses, the HUD panel 200 includes an electro-optical element, such as the TN cell 220 to modulate the polarization from the TFT-LCD 222. The HUD panel 200 may include a wavelength filter, such as the hot mirror 224, to increase the sunlight resistance of the TFT-LCD 222. In a traditional HUD panel 200, adding these two extra elements in front of the TFT-LCD 222 introduces four additional optical surfaces, which can induce ghost images. These ghost images reduce the contrast of the WHUD content. To eliminate the ghosting, the HUD panel 200 is stacked in such a configuration to eliminate the additional optical surfaces. For example, by properly stacking various elements, such as the TFT-LCD 222, the TN cell 220, and the hot mirror 224, the additional optical surfaces are eliminated. As described in one or more embodiments, properly stacking various elements of the HUD panel 200 may include stacking the hot mirror 224 in front of the TN cell 220, which is stacked in front of the LCD 222. In this configuration, a PGU of the WHUD system can maintain its polarized sunglasses compatibility and sunlight resistance requirements.

FIG. 2B illustrates a stacked HUD panel 201 with an air gap in accordance with aspects of the present disclosure. The stacked HUD panel 201 can be configured as follows: 1) the anti-reflection and infrared cut-off coating 202 is positioned adjacent the active polarization modulator front plate 204; 2) the first LC 206 is positioned between the active polarization modulator front plate 204 and the active polarization modulator rear plate 208; 3) a first linear polarizer 226 is positioned adjacent the active polarization modulator rear plate 208; 4) an air gap 230 is positioned between the first linear polarizer 226 and a second linear polarizer 228; 5) the LCD front plate 212 is positioned between the second linear polarizer 228 and the second LC 214; 6) the second LC 214 is positioned between the LCD front plate 212 and the LCD rear plate 216; and 5) the second reflective polarizer 218 is positioned adjacent the LCD rear plate 216. The stacked HUD panel 201 can include additional and/or fewer components and configurations and is not limited to those illustrated in FIG. 2B.

In this embodiment, the TN cell 220 can be separated from TFT-LCD 222. The TN cell 220 and the TFT-LCD 222 do not share the same linear polarizer. TFT-LCD 222 can have a front linear polarizer (e.g., the second linear polarizer 228) and the TN cell 220 can have its own linear polarizer (e.g., the first linear polarizer 226) on a surface toward the TFT-LCD 222. The linear polarizers 226, 228 can be absorptive to reduce ghost image visibility. There is an air gap 230 in between these two linear polarizers 226, 228. Air flow can be forced to pass through the air gap 230 in order to take heat away from both linear polarizers 226, 228.

Table 1 shown below illustrates power consumption comparisons of PGUs to meet 950 cd/m² V-polarized Brightness and 15000 cd/m² Total Brightness requirements.

TABLE 1

| | V-Polarized | | Total | | |
|---|---|---|---|---|---|
| | Brightness | | Brightness | | Normalized PGU |
| Sports Car | (cd/m²) | | (cd/m²) | | Power |
| S-polarized TFT- | 950 | | 62408 | | 4.16 |
| LCD PGU | | | | | |
| 45° linear polarized | 1088 | | 15000 | | 1.84 |
| TFT-LCD PGU | | | | | |
| 42° linear polarized | 950 | | 15276 | | 1.72 |
| TFT-LCD PGU | | | | | |
| Active TN cell PGU | ON: | OFF: | ON: | OFF: | 1 |
| | 950 | 234 | 965 | 15364 | |

As shown in Table 1, a PGU with the active TN cell 220 is more efficient than an S-polarized TFT-LCD PGU, a 45° linear polarized TFT-LCD PGU, and a 42° linear polarized TFT-LCD PGU. The WHUD system with the active TN cell 220 is therefore more efficient. The WHUD system with the active TN cell 220 has lower light energy absorption on an LCD in an ON condition for the V-polarized brightness and an OFF condition for the total brightness. In this example, V-polarized refers to the light that is vertically polarized to the ground. There can be some power in V-polarization while the output from the PGU are all S-polarization due to the windshield azimuth angle. Furthermore, using the active TN cell 220 in the HUD panel 200 results in a lower temperature rise on the LCD and a lower current demand for a light-emitting diode (LED).

The TN cell 220 can be positioned or sandwiched between two plates made of glass. The hot mirror 224 is an optical mirror reflecting infrared (IR) and allowing visible light to pass through. The hot mirror 224 may need a substrate to carry a thin film coating. Usually the thin film is designed to be low reflection in the visible light spectrum and high reflection in the infrared spectrum. Thus, the TN cell 220 can be the substrate of the thin film coating to provide both polarization control and hot mirror 224 functions simultaneously. This stacked configuration of the HUD panel 200 eliminates two surfaces. The TN cell 220 and hot mirror 224 are integrated in the HUD panel 200 and can be optically bonded to the TFT-LCD 222 to eliminate another two surfaces. After this integration, the HUD panel 200 has only two optical surfaces, which is the same amount of optical surfaces as a traditional TFT-LCD 222.

A first polarizer, such as the first reflective polarizer 210 can be located on a front plate, such as the LCD front plate 212 of the TFT-LCD 222. The first reflective polarizer 210 can be a reflective type to reflect the excess amount of solar radiation from heating the entire stack. A second polarizer, such as the second reflective polarizer 218, can be located on a rear TFT-LCD plate, such as the LCD rear plate 216. The second reflective polarizer 218 can also be a reflective type to reflect the unusable portion of the flux from backlight from heating the entire stack. Such example configurations can prevent or reduce ghosting and stray light.

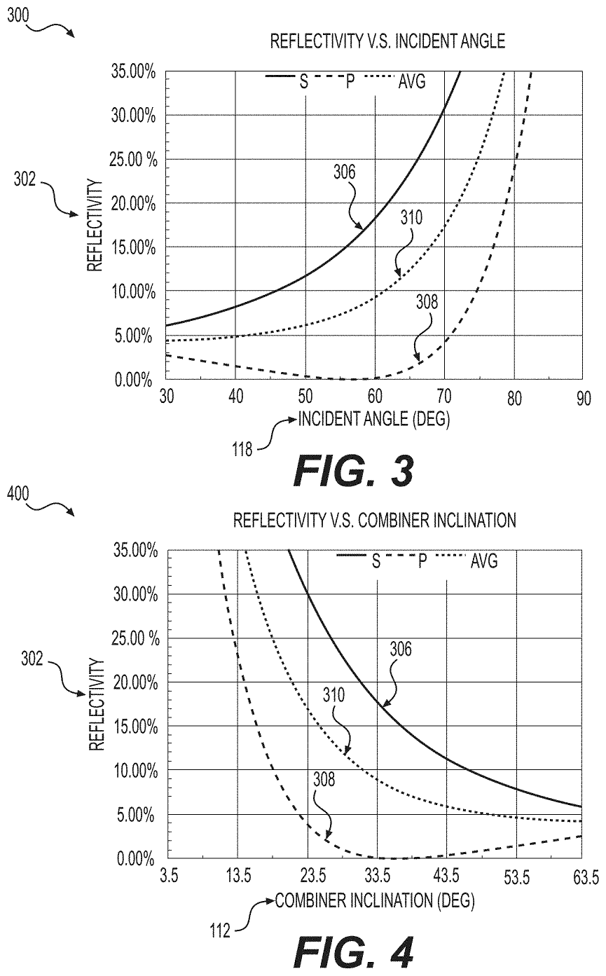

FIG. 3 is a graph 300 that illustrates qualitative behavior of light reflectivity 302 versus angle of incidence, or an incident angle 118, in accordance with aspects of the present disclosure. As the incident angle 118 increases in degrees (e.g., from 30 degrees to over 70 degrees), the percentage of reflectivity 302 increases for an S-polarized light 306 from about 6% to 35%. As the incident angle 118 increases in degrees from 30 degrees to approximately 60 degrees, the reflectivity 302 of a P-polarized light 308 decreases from about 3% to approximately no reflectivity. When the incident angle 118 increases from approximately 60 degrees to 83 degrees, the reflectivity 302 increases from approximately 0% to 35%. An average polarized light 310 represents an average reflectivity 302 of the S-polarized light 306 and the P-polarized light 308 as the incident angle 118 changes. Polarized sunglasses let only the P-polarized light 308 pass through. Thus, a person who wears polarized sunglasses can hardly see the image from an S-optimized HUD panel 200. The HUD panel 200 can be optimized for higher reflectivity.

FIG. 4 is a graph 400 that illustrates qualitative behavior of light reflectivity 302 versus a combiner inclination (ω) 112 with a look down angle (α) 114 of 3.5 degrees in accordance with aspects of the present disclosure. As combiner inclination (ω) 112 increases in degrees (e.g., from approximately 20 degrees to 63.5 degrees), the percentage of reflectivity 302 decreases for the S-polarized light 306. As the combiner inclination (ω) 112 increases in degrees from approximately 10 degrees to 33.5 degrees, the reflectivity 302 of the P-polarized light 308 decreases from about 35% to approximately no reflectivity. When the combiner inclination (ω) 112 increases from approximately 33.5 degrees to 63.5 degrees, the reflectivity 302 increases from approximately 0% to 3%. An average polarized light 310 represents an average reflectivity 302 of the S-polarized light 306 and the P-polarized light 308 as the incident angle 118 changes. An average polarized light 310 represents an average reflectivity 302 of the S-polarized light 306 and the P-polarized light 308 as the combiner inclination (ω) 112 changes.

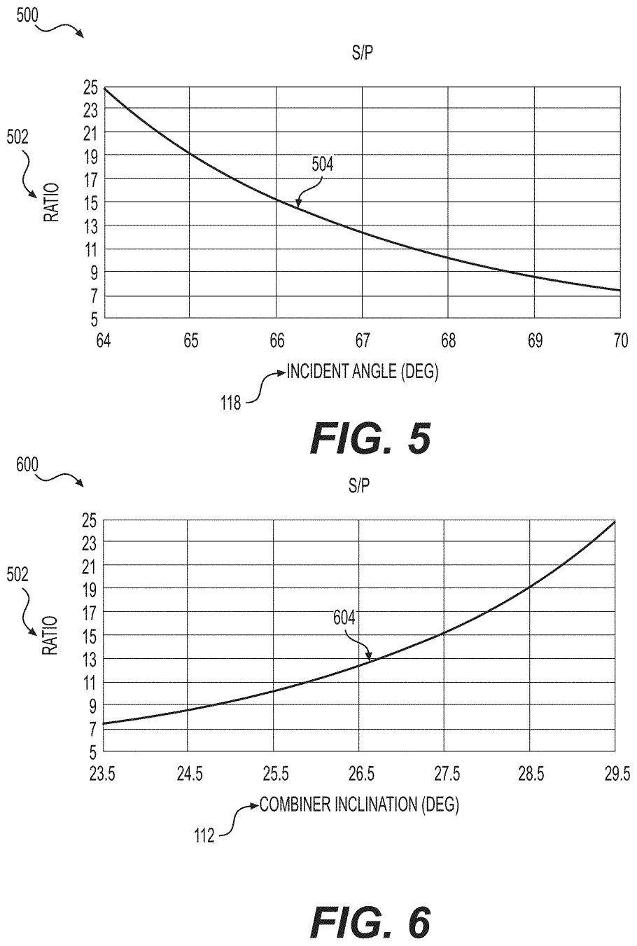

FIG. 5 is a graph 500 that illustrates qualitative behavior 504 of the S-polarization and P-polarization reflectivity ratio of light, or the reflectivity ratio 502, versus angle of incidence, or the incident angle 118, in accordance with aspects of the present disclosure. In this example, the reflectivity ratio 502 is the reflectivity of the S-polarized light 306 divided by the P-polarized light 308. As the incident angle 118 increases from 64 degrees to 70 degrees, the reflectivity ratio 502 decreases from approximately 25 to 7. Polarized sunglasses allow only the P-polarization 308 to pass through. Although not shown in FIG. 5, when the incident angle 118 is approximately 57 degrees, the reflectivity ratio 502 of the S-polarization 306 is much greater than the reflectivity 502 of the P-polarization 308. The trend in FIG. 5 is that the ratio 502 increases as the incident angle 118 decreases. For example, the ratio 502 can go toward infinity at 57 degrees because the P-polarization reflectance goes to 0.

FIG. 6 is a graph 600 that illustrates qualitative behavior 604 of an S-polarization and P-polarization reflectivity ratio of light, or the reflectivity ratio 502, versus a combiner inclination (ω) 112 in accordance with aspects of the present disclosure. As the combiner inclination (ω) 112 increases from 23.5 degrees to 29.5 degrees, the reflectivity ratio 502 increases from approximately 7 to 25.

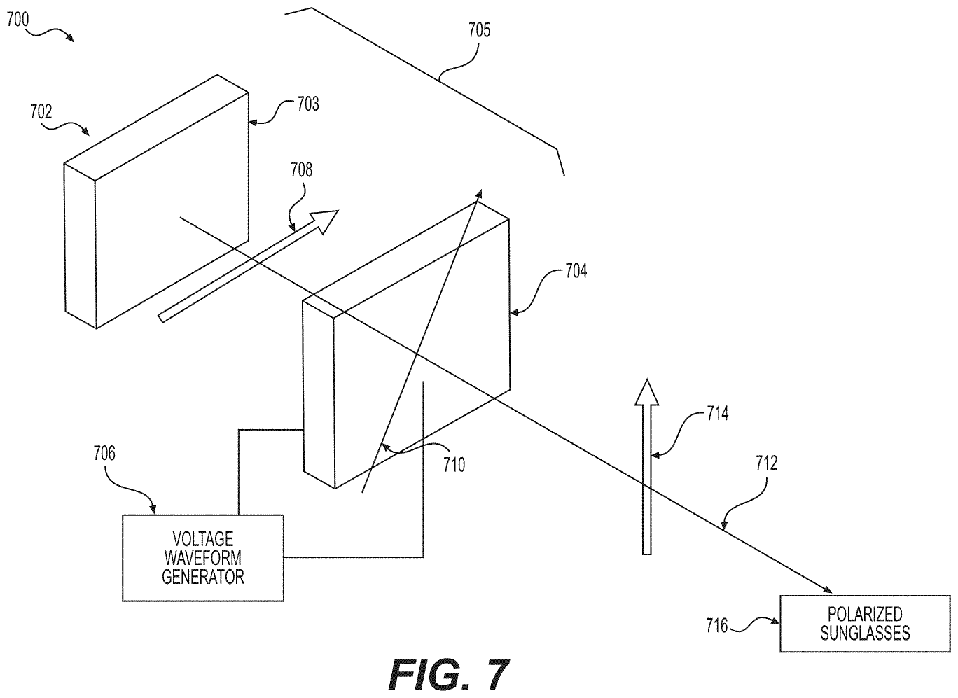

FIG. 7 is a diagram of an electrical polarization rotator 700 of the HELD panel 200, which can include stacked components 705, such as a display panel 703 and an electro-optical half-wave plate 704, in accordance with aspects of the present disclosure. The display device 702 is compatible with polarized sunglasses 716. The polarization of sunglasses is disclosed in U.S. patent application Ser. No. 15/602,997, which is hereby incorporated by reference in its entirety. The display device 702 includes a display, such as a linear polarized display panel 703, for displaying information. The display device 702 includes components that may be stacked to reduce internal surfaces. The components may include the TFT-LCD 222, the TN cell 220, and the hot mirror 224 as described in FIGS. 2A and 2B. The stacked components 705, including the display panel 703 and the electro-optical half-wave plate 704 can be configured to reduce a ghost image on the display 703. The stacked components 705 can include additional and/or fewer components and configurations and is not limited to those illustrated in FIGS. 2A, 2B, and 7.

The display panel 703 can be configured either to output S-polarized light 306 or P-polarized light 308. The either S-polarized light 306 or P-polarized light 308 can travel between the display panel 703 and the half-wave plate 704 along an optical axis 712. For illustrative purposes, either the S-polarized light 306 or P-polarized light 308 is polarized in the direction of 708 while the direction 714 is orthogonal to the direction of 708.

The HUD panel 200 can include a half-wave plate 704 coupled to the either S-polarized or P-polarized display panel 703. The half-wave plate 704 can be arranged to receive any polarization of light from the display panel 703.

The HUD panel 200 can also include a voltage waveform generator 706. The voltage waveform generator 706 can be coupled to the half-wave plate 704. The voltage waveform generator 706 can be configured to orient a fast axis 710. The voltage waveform generator 706 can orient the fast axis 710 at 45 degrees with respect to the linear polarized light polarization from display panel 703 to modulate the polarization to the orthogonal direction perpendicular to optical axis, or to any other desirable linear polarization state via other desirable fast axis angle with respect to the linear polarized light polarization from display panel 703. The voltage waveform generator 706 can be an ON/OFF switch. For example, by switching the polarization of PGU to the P state (e.g. the ON state), the image content can be seen by a person wearing polarized sunglasses. By switching the polarization of PGU to the S state (e.g. the OFF state), the image content cannot be seen by a person wearing polarized sunglasses.

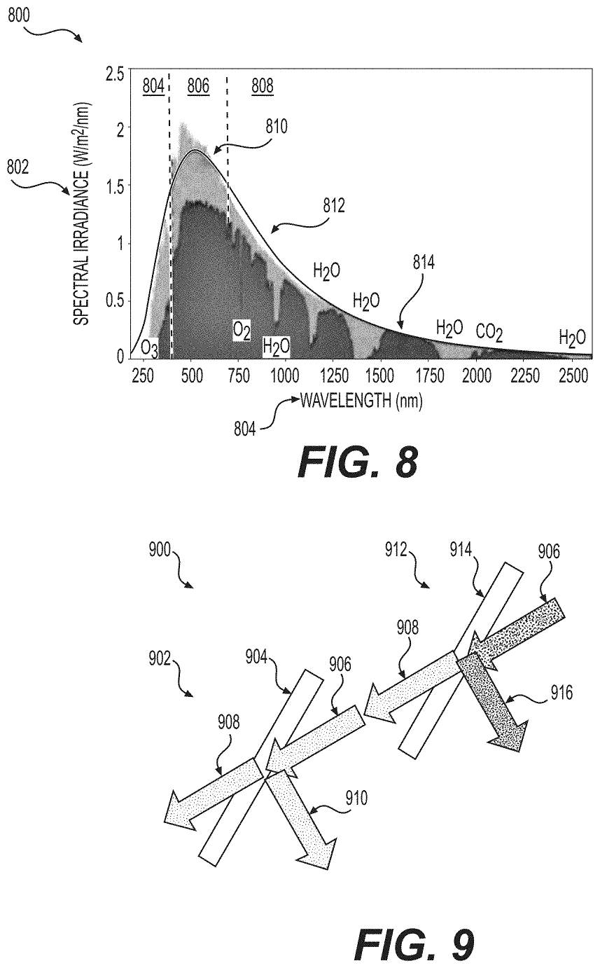

FIG. 8 is a graph 800 illustrating sun loading from solar radiation in accordance with aspects of the present disclosure. In this example, a solar radiation spectrum (e.g. electromagnetic radiation spectrum) or spectral irradiance 802 includes spectrums of 5% ultraviolet (UV) light 804, 40% visible light 806, and 55% IR light 808. The UV light 804 is electromagnetic radiation with wavelengths of approximately 250 nm to 400 nm. The visible light 806 is electromagnetic radiation with wavelengths of approximately 400 nm to 700 nm. The a light 808 is electromagnetic radiation with wavelengths of approximately 700 nm to over 2500 nm.

When sunlight is at the top of the atmosphere at radiation level 810, the spectral irradiance 802 peaks at approximately 2 W/m²/nm in the visible light spectrum 806. The spectral irradiance 802 decreases as the wavelengths increase through the IR light spectrum 808. The radiation level 810 can be approximated to the radiation level 812 which is the 5250 degrees Celsius black-body radiation. At radiation level 814, the radiation is at sea level and absorption from atmosphere molecules causes the spectral irradiance 802 begins to plateau.

FIG. 9 is a diagram 900 showing reflective and transmitted light in accordance with aspects of the present disclosure. In one embodiment, a combination of at least two optical filters can be used to prevent excessive radiation energy heating the TFT-LCD 222. The optical filters can include at least one of a reflective polarizer 904, a TN cell 220, and a hot mirror 224. In this configuration, most of the IR light can be rejected and approximately half of the visible light can be rejected. For example, the reflective polarizer 904 can be used to transmit approximately half or 50% of the visible light and a hot mirror 914 can be used to reflect most or all of the IR light.

Diagram 902 includes the reflective polarizer 904. The reflective polarizer 904 can be on the TN cell 220 or on the TFT-LCD 222. In this configuration, sunlight 906 passes through the reflective polarizer 904 in a direction 908. Approximately 50% of the visible light from sunlight 906 is transmitted in the direction 908 and 50% of the visible light from sunlight 906 is reflected in a direction 910.

Diagram 912 includes a hot mirror 914. The hot mirror 914 can be the TN cell 220 or the hot mirror 224. In this configuration, sunlight 906 passes through the hot mirror 914 in a direction 908. Most of the visible light from sunlight 906 is transmitted in the direction 908 and most of the IR light is reflected in a direction 916.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A head-up display (HUD), comprising:
a thin-film transistor liquid crystal display (TFT-LCD);
an active polarization modulator; and
a wavelength filter;
wherein the active polarization modulator and the wavelength filter are optically bonded to the TFT-LCD.

2. The HUD of claim 1, wherein the active polarization modulator is configured to modulate a polarization from the TFT-LCD.

3. The HUD of claim 1, wherein the active polarization modulator is a liquid crystal cell.

4. The HUD of claim 1, further comprising:
a first linear polarizer, wherein the first linear polarizer is positioned adjacent the active polarization modulator;
a second linear polarizer, wherein the second linear polarizer is positioned adjacent the TFT-LCD; and
an air gap, wherein the air gap is positioned between the first and second linear polarizers.

5. The HUD of claim 3, wherein the liquid crystal cell is configured as a substrate of a thin film coating.

6. The HUD of claim 3, wherein the liquid crystal cell is configured to control polarization and as the wavelength filter simultaneously.

7. The HUD of claim 1, wherein the wavelength filter is configured to increase a sunlight resistance of the TFT-LCD.

8. The HUD of claim 1, wherein the wavelength filter is a wavelength dependent mirror.

9. The HUD of claim 1, wherein the HUD is coupled to a windshield.

10. A system for a HUD, comprising:
an active polarization modulator front plate;
a coating adjacent to the active polarization modulator front plate;
an active polarization modulator rear plate adjacent to the active polarization modulator front plate;
a first reflective polarizer adjacent to the active polarization modulator rear plate;
an LCD front plate adjacent to the first reflective polarizer;
an LCD rear plate adjacent to the LCD front plate; and
a second reflective polarizer adjacent to the LCD rear plate.

11. The system for the HUD of claim 10, further comprising:
a first liquid crystal (LC) positioned between the active polarization modulator front plate and the active polarization modulator rear plate; and
a second LC positioned between the LCD front plate and the LCD rear plate.

12. The system for the HUD claim 10, wherein the coating has low reflectivity in a visible light spectrum and high reflectivity in a non-visible light spectrum.

13. The system for the HUD claim 10, wherein the first reflective polarizer is configured to reflect solar radiation.

14. The system for the HUD claim 10, wherein the second reflective polarizer is configured to reflect an unusable portion of a flux from a backlight.

15. A display device compatible with polarized sunglasses, comprising:
a display for displaying information, the display includes components arranged to reduce internal surfaces; and
a half-wave plate coupled to the display and arranged to receive S-polarized light from the display, wherein the half-wave plate outputs the P-polarized light; and
wherein the components reduce a ghost image on the display.

16. The display device of claim 15, wherein the components further comprise:
a voltage waveform generator, the voltage waveform generator coupled to the half-wave plate and configured to orient a fast axis.

17. The display device of claim 15, wherein the fast axis is oriented to form an angle with the S-polarized light of approximately 45 degrees.

18. The display device of claim 15, wherein the display device provides as an output S-polarized light traveling toward the polarized sunglasses.

19. The display device of claim 15, further comprising:
at least two optical filters, wherein the at least two optical filters include at least one of a reflective polarizer, a LC cell, and a wavelength dependent mirror.

20. The display device of claim 19, wherein the at least two optical filters reject infrared (IR) light and visible light.
